(19) United States
(12) Patent Application Publication
(10) Pub. No.: US 2008/0220390 A1
(43) Pub. Date: Sep. 11, 2008

(54) Dental tool guide assembly

(76) Inventor: Michael Klein, Cedarhurst, NY (US)

Correspondence Address: Thomas M. Galgano, Suite 204, 20 W. Park Avenue, Long Beach, NY, 11561, US

(21) Appl. No.: 12/074,977

(22) Filed: Mar. 7, 2008

Related U.S. Application Data
(60) Provisional application No. 60/905,502, filed on Mar. 7, 2007.

(51) Int. Cl. A61C 3/02

(52) U.S. Cl. 433/76

(57) ABSTRACT

A dental tool guide assembly includes a master or fixed sleeve having a central bore and a removable sleeve insert having a central bore which fits into the fixed sleeve. The fixed sleeve and removable sleeve insert each have a cut away side section which are alignable when the removable sleeve insert is inserted into the fixed sleeve. The cutaway side sections allow an upright tool to be brought laterally and radially-inward through the outer fixed sleeve and inner removable sleeve and then vertically downward through the bore of the removable sleeve. This design allows easier access to the osteotomy site without requiring the patient to open their mouth by a painful amount. The design also allows the use of longer drills in smaller mouths. The removable sleeves are preferably provided with a variety of inner bore diameters but all having the same outer diameter which closely correspond to the inner diameter of the bore of the fixed sleeve.

### CROSS-REFERENCE TO RELATED APPLICATIONS

This application claims the benefit of application Provisional Application Ser. No. 60/905,502, filed Mar. 7, 2007, the complete disclosure of which is incorporated by reference herein.

### INCORPORATION BY REFERENCE

The complete disclosures of co-assigned U.S. Pat. No. 5,967,777 and co-assigned U.S. Pat. No. 6,793,491 are incorporated by reference herein.

### BACKGROUND OF THE INVENTION

1. Field of the Invention

This invention relates broadly to equipment used to install dental implants. More particularly, this invention relates to a drill sleeve/bushing guide assembly which includes a fixed sleeve and a removable sleeve insert which fits into the fixed sleeve. The fixed sleeve and removable sleeve insert each have a central bore and each have a cut away side section which cut away side sections are alignable when the sleeve insert is inserted into the fixed sleeve. When so aligned, a dental drill can be moved laterally radially inward through the cut-away side sections of both sleeves and then vertically downward through the central bore of the removable sleeve insert to permit drilling in the patient's jawbone to accommodate a dental implant.

2. State of the Art

Holes/osteotomies are created in the jawbone in specific dimensions and locations to accommodate dental implants. The locations of the holes/osteotomies are very specific to enable supporting of various types of dental prostheses. When installing dental implants into a patient's jawbone, especially when numerous teeth must be replaced or created, it is advantageous to use a dental surgical template to aid in the positioning and orientation of the dental implant drill with respect to the jawbone. The surgical template is typically comprised of a plastic, acrylic or vinyl replica of the prospective teeth to be supported by dental implants. The surgical template is then modified and readied for surgical use by manually cutting holes in the approximate and prosthetically desirable areas where the surgeon anticipates he or she will place dental implants. These holes are made large enough to accommodate the passage of a dental implant drill, bur and/or guide pin.

Initially, indications are made on the template where the teeth are to be located. Such templates and markings used to be made by the dentist directly in the mouth based upon his/her own estimation. Recently computer programs have been available to assist in creating such indications.

For example, radiopaque markers may be applied to the surgical template by applying a radiopaque material (e.g.: barium sulfate, gutta percha, silver powder-acrylic mixture, etc.) to or below the surface of the replica teeth of the template to create what is generally known as a CT scan appliance. These radiopaque markers demonstrate on a CT scan image the tooth outline and/or position of the prospective tooth or teeth to be implanted. The patient wears the CT scan appliance and a CT scan is obtained of the jawbone prior to having dental implant surgery. The radiopaque markers of the CT scan appliance are readily discernible on the CT scan images and thus allow the surgeon or dentist to evaluate the available bone relative to the radiopaque tooth position markers at the proposed implant site. Currently available software, e.g., SIM/PLANT manufactured by Columbia Scientific, Inc. of Columbia, Md., reformats such CT scan data into 2- and 3-dimensional images that allow for interactive evaluation of the jawbone at proposed implant sites and surgical treatment planning by the dental implant therapist. The software further enables the dental implant therapist to perform a dental implant simulation directly onto the reformatted CT scan images. In essence, the implant surgeon can create a simulated dental implant surgical treatment plan or surgical blueprint on the patient's CT scan images.

Co-assigned U.S. Pat. No. 5,967,777 describes a method by which the three dimensional data coordinates of the above described simulated dental implant positions are transferred to a CNC milling machine that precisely mills and cuts holes into the CT scan appliance to create a surgical template. This precision computer-milled surgical template is then mated with drill guide components that precisely and accurately guide the drilling or osteotomy (i.e., drilled hole in the jawbone) creation process used at the time of dental implant surgery. It is even possible, under certain circumstances, to actually insert the dental implant through this computer-milled surgical template assembly and directly into the patient's jawbone. When this computer-milled precision surgical template assembly is refitted to the patient's mouth at the time of implant surgery, the surgeon's drill is precisely guided to create implant osteotomies that accurately correspond in three dimensional position and trajectory to the simulated implant positions of the pre-surgical computerized surgical blueprint treatment plan. As further noted therein, sleeve/bushing systems may be embedded into appliances that are worn by the patient while surgery is performed. The sleeve systems guide the dental drills or tools that are used to create the holes/osteotomies into the jawbone. When drilling these osteotomies, a small diameter drill is first used and then subsequent larger diameter drills as used to enlarge the osteotomy/hole. These drills or tools must be of adequate length to drill the precise osteotomy depth while passing through the sleeve systems.

Moreover, when using any surgical template to assist in the drilling of dental implant osteotomies, it is generally desirable for the surgical template to be stable as well as removable and accurately repositionable in the patient's mouth. If the surgical template is not stable, then the accuracy of the drilling process may be compromised, possibly leading to poor implant positioning and/or injury to the patient. Surgical template stability and/or fixation is required to reduce surgical drilling error and enhance proper implant positioning.

The computer-milled surgical template-assembly described in U.S. Pat. No. 5,967,777 requires absolute stability during its use. This template assembly is usually supported and stabilized by the patient's existing teeth or sometimes a combination of teeth and other prosthetically restored teeth or implants. However, in the absence of adequate existing support required to provide necessary stabilization (e.g. in the case of complete edentulism), a method to provide such required support and stabilization is needed.

Co-assigned U.S. Pat. No. 6,793,491 discloses a system of stabilizing implants at specifically determined locations on a patient's jawbone for positioning and temporarily stabilizing a dental surgical template at a fixated and stabilizing orientation with respect to the jawbone. The dental surgical template is provided with components that allow the accurate reproducible mechanical integration of the template to the system of implants. Once the surgical template is secured and fixed to the temporary stabilizing implants, the template may be used to create osteotomies in a patient's jawbone at locations where more permanent dental implants will be installed. The template is provided with “master cylinder components” (i.e., fixed sleeves) which are fixedly mounted in the template at the locations where osteotomies are to be created. Drill guides (i.e., removable sleeves) of varying diameter are inserted into the master cylinder components. Typically, an osteotomy is created by first drilling with a narrow diameter drill through a narrow diameter drill guide inserted into the master cylinder component. This is followed by progressively larger diameter drills through larger diameter drill guides. The master cylinder components are each preferably provided with a circumferential slot and the drill guides are each preferably provided with a radially extending key which engages the slot by rotating the drill guide in the master cylinder component.

The temporary stabilizing implants allow for the subsequent removal and accurate repositioning and fixation of the surgical template to allow for the accurate position the surgical template during a variety of successive time periods. Once the osteotomies have been created and the dental implants installed, and/or the dental surgical template is no longer needed to plan and/or verify the location of the implant surgery, the temporary stabilizing implants may be removed from the patient's jawbone.

Notwithstanding the foregoing advances, patients nevertheless have a limited ability to open their mouths wide. On occasion, the drill or tool length is too great for a patient's mouth opening. The upright drill must be able to be placed into the drill guide insert sleeve which means it is moved over the appliance holding the sleeve and placed into the sleeve from over the top end of the sleeve. This is sometimes physically impossible to do due to the limited mouth opening of the patient.

### SUMMARY OF THE INVENTION

It is therefore an object of the present invention to provide a novel dental drill/tool sleeve assembly which may be used for guiding dental drills or tools.

It is a further object of the invention to provide such a sleeve assembly which provides easy access to the dental drill site and allows the use of drill tools of greater length without requiring the patient's mouth to be opened wider.

According to the present invention, a drill sleeve/bushing assembly is provided which includes a fixed sleeve and a removable sleeve insert which fits into the fixed sleeve. The fixed sleeve and removable sleeve insert each have a cut away side section which cut away side sections are alignable when the removable sleeve insert is inserted into the fixed sleeve. The cutaway side sections allow a drill to be brought laterally and in a radially inward direction through the outer fixed sleeve and inner removable sleeve and then vertically or axially downward through the removable sleeve. This design allows easier access to the osteotomy site via the cut away side sections without requiring the patient to open their mouth by a painful amount. The design also allows the use of longer drills in smaller mouths. The removable sleeves are preferably- provided with a variety of inner bore diameters but, all having the same outer diameter which corresponds closely to the inner diameter of the fixed sleeve(s). The fixed sleeves are advantageously incorporated into a template such as those described in the previously incorporated co-assigned patents.

Certain of the foregoing and related objects are attained according to the present invention by the provision of a dental tool guide assembly, comprising a master sleeve having a generally cylindrical wall defining an axially-extending, centrally arranged through hole and a cut-out in said cylindrical wall thereof and a generally cylindrical removable sleeve removably mountable within said through hole of said master sleeve and having a generally cylindrical wall defining an axially-extending, centrally arranged through hole and a cut-out in said cylindrical wall thereof, wherein said removable sleeve is rotatable within said master sleeve so as to permit alignment of said cut-outs thereof to permit a generally upright dental tool to pass laterally and radially inward through said cut-outs until it is located within the through hole of said removable sleeve whereupon it may be moved axially downwardly through said through hole of said removable sleeve to perform a dental task on a patient.

Preferably, the master sleeve has an upper end and a lower end, and the cut-out thereto extends from approximately the upper end thereof to a location above the lower end thereof. The cut-out preferably has a width no greater than 180° and desirably of no greater than approximately 90°.

Similarly, the removable sleeve cylindrical portion has an upper end and a lower end, and a cut-out extending from the upper end thereof to a location above the lower end thereof. The cut-out also preferably has a width no greater than approximately 180° and desirably no greater than approximately 90°.

Most advantageously, the cut-outs in the master and removable sleeves correspond in size. The removable sleeve desirably has an outer diameter slightly less than the diameter of the through hole of the master sleeve. In a preferred embodiment, the guide assembly additionally includes a plurality of removable sleeves, each having a through hole of a different diameter.

Most desirably, the guide assembly additionally includes means for aligning and locking the position of said master sleeve and said removable sleeve so their respective cut-outs are aligned with one another.

Most advantageously, the means includes a key and a keyway and one of the master sleeve and the removable sleeve is provided with a key and the other thereof is provided with a keyway in which the key is receivable so as to lock the sleeves in a fixed position relative to one another in which said cut-buts thereof are aligned. The cut-out in the removable sleeve is dimensioned and configured to provide approximately 180° lateral access to said through-hole thereof.

Additional objects and advantages of the invention will become apparent to those skilled in the art upon reference to the detailed description taken in conjunction with the provided figures.

### BRIEF DESCRIPTION OF THE DRAWINGS

FIG. 1 is a front elevation view of a fixed sleeve according to the invention;

FIG. 2 is a side elevation view of the sleeve of FIG. 1;

FIG. 3 is a top plan view of the sleeve of FIGS. 2 and 3;

FIG. 4 is a front elevation view of a removable sleeve according to the invention

FIG. 5 is a top plan view of the sleeve of FIG. 4;

FIG. 6 is a side elevation view of the sleeve of FIG. 4;

FIG. 7 is a perspective view of a second embodiment of a fixed sleeve according to the invention;

FIG. 8 is a top plan view of the sleeve of FIG. 7;

FIG. 9 is a front elevation view of the sleeve of FIG. 7;

FIG. 10 is a side elevation view of the sleeve of FIG. 7;

FIG. 11 is a perspective view of a second embodiment of a removable sleeve according to the invention;

FIG. 12 is a top plan view of the sleeve of FIG. 11;

FIG. 13 is a side elevation view of the sleeve of FIG. 11;

FIG. 14 is a perspective view of the sleeve of FIG. 11 inserted into the sleeve of FIG. 7 and rotated into aligned and locked position;

FIG. 15 is a top plan view of the sleeve of FIG. 11 inserted into the sleeve of FIG. 7 and rotated into aligned and locked position;

FIG. 16 is a front elevation view of the sleeve of FIG. 11 inserted into the sleeve of FIG. 7 and rotated into aligned and locked position; and

FIG. 17 is a side elevation view of the sleeve of FIG. 11 inserted into the sleeve of FIG. 7 and rotated into aligned and locked position.

### DETAILED DESCRIPTION OF THE PREFERRED AND ILLUSTRATED EMBODIMENTS

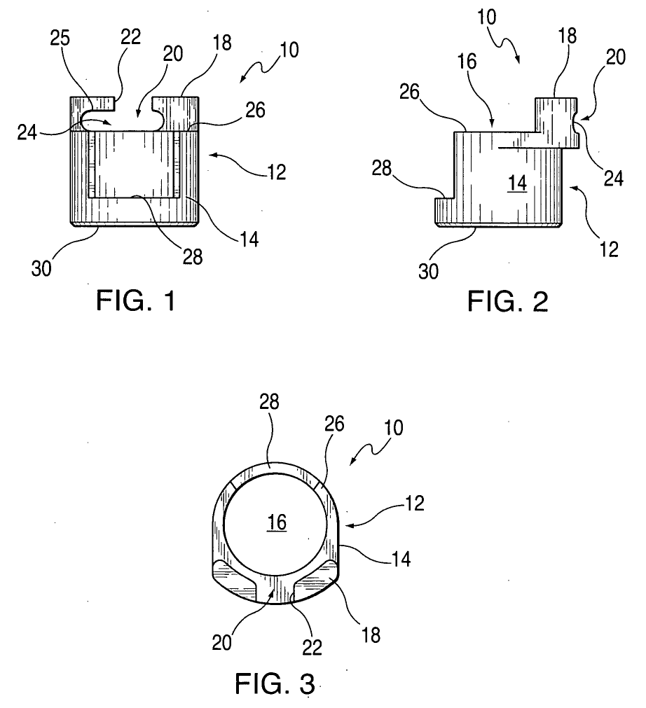

Turning now to FIGS. 1-3, a fixed or master cylinder or sleeve 10 according to a first embodiment of the invention includes a generally cylindrical portion 12 having an outer wall 14 and defining a central, axially-aligned and vertically-extending through hole or bore 16. A radially outward extending flange 18 is preferably located at the top of the cylindrical portion 12. The flange 18 preferably defines a bayonet keyway 20 which has a vertical opening 22 and a lateral opening 24 which is wider than the vertical opening and which defines a locking location 25 which is laterally spaced apart from the vertical opening 22. According to the invention, the outer wall 14 of the cylindrical portion 12 is preferably cut from the top 26 of the cylindrical portion 12 to a point 28 above the bottom 30 of the cylindrical portion 12 thereby defining a side opening to access the through hole 16. The width of the cut can be defined as an angular measurement. In the illustrated embodiment, the angle is less than 90°. The fixed sleeve 10 is preferably incorporated into a template such as those described in the previously incorporated co-assigned patents and the template is preferably modified to have a side cut corresponding to the side opening in the outer wall 14 of the fixed sleeve 10.

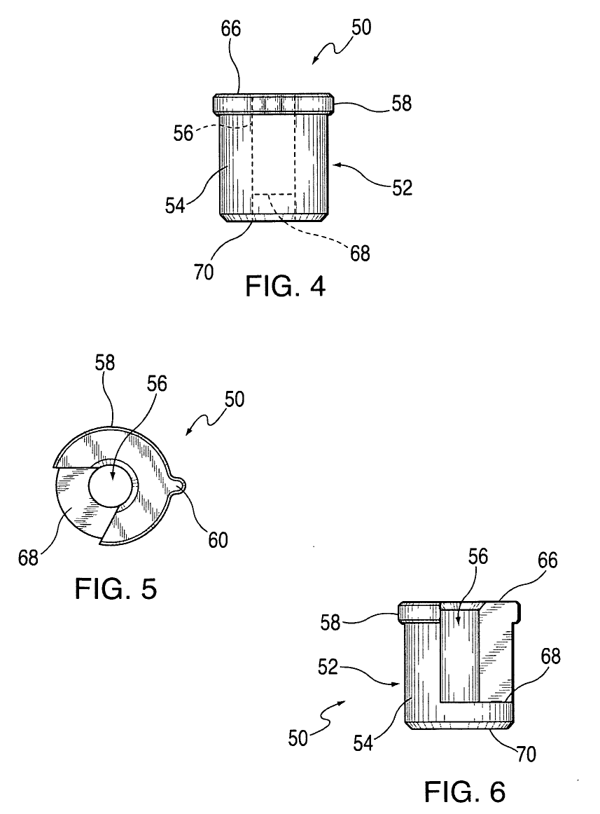

Referring now to FIGS. 4-6, a removable bushing or sleeve 50 according to the first embodiment of the invention includes a generally cylindrical portion 52 having an outer wall 54 and defining a central, axially aligned and vertically-extending through hole or bore 56. A radially outward extending flange 58 is preferably located at the top of the cylindrical portion 52. A key 60 preferably extends radially outward from the flange 58. According to the invention, the outer wall 54 is preferably cut from the top 66 of the flange 58 to a point 68 in the outer wall 54 above the bottom 70 of the outer wall 54 thereby defining a side opening to provide lateral access to the through hole 56. The width of the cut can be defined as an angular measurement. In the illustrated embodiment, the angle is less than 90°. The outer diameter of the cylindrical portion 52 is dimensioned to fit snugly into the through hole 16 of the fixed sleeve 10 (FIGS. 1-3). The flange 58 is dimensioned to fit into the flange 18 of the fixed sleeve 10 with the key 60 extending through the vertical opening 22 and lateral opening 24 of the bayonet keyway 20.

In use, the sleeve 50 is inserted into the sleeve 10 with the key 60 dropping vertically through the vertical opening 22 of the bayonet keyway 20. The sleeve 50 is then rotated so that the key 60 traverses the lateral opening 24 of the keyway 20 until it is positioned at the locking location 25. At the locking location, the lateral opening in the wall 54 aligns with the lateral opening in the wall 14. According to the invention, multiple removable sleeves 50 are provided, each having a different diameter through hole 56. In practice, a sleeve 50 with a relatively small diameter through hole 56 is inserted first into the sleeve 10 and locked in position. A generally upright dental drill (not shown) having a diameter corresponding to the diameter of the through hole 56 is moved laterally and axially inward through the lateral opening in the fixed sleeve 10 and the lateral opening in the removable sleeve 50 until it is axially aligned with the center of through hole 56 and it is then moved vertically downward into the through hole 56 to drill a guide hole in the patient's jaw bone. Thereafter, the sleeve 50 is removed and optionally replaced with a sleeve having a larger diameter through hole 56. This process may be repeated several times until the final desired diameter hole in the patient's jaw bone is achieved.

It should be noted that although the cut-away sections of the fixed sleeves 10 and removable sleeves have a cut-away section of preferably less than 90% at their outer circumference, there is approximately 180° lateral access provided at the inner through hole or bores 56, 156 to permit the dental drill or tool to pass laterally into the through-bore 56, 156. As can be appreciated, the diameter of the dental drill or tool is slightly less than the diameter of the through-bore 56, 156 to permit it to be moved axially downwardly through through-bore 56, 156 after it is first laterally moved and radially inwardly shifted through the cut-outs or cut-away sections of the fixed and removable sleeves.

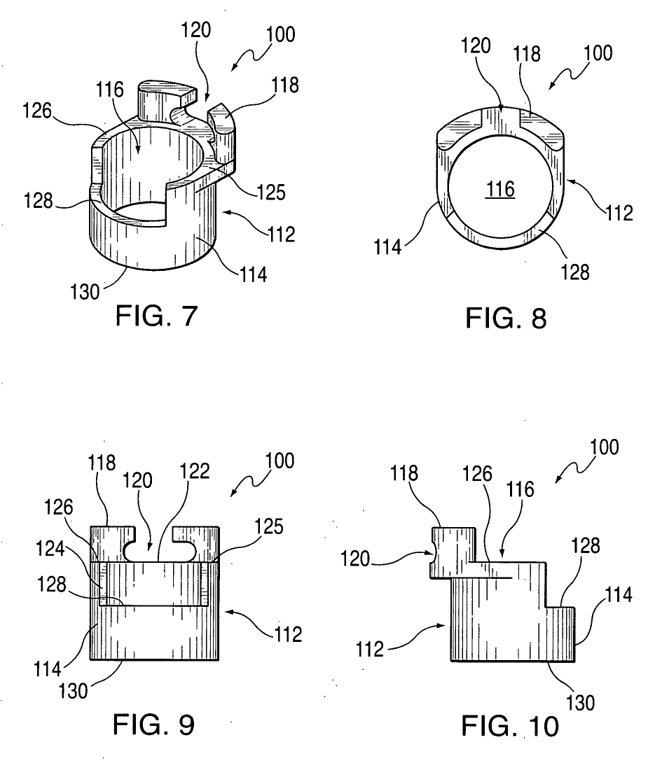

Turning now to FIGS. 7-10, a fixed sleeve 100 according to a second embodiment of the invention includes a generally cylindrical portion 112 having an outer wall 114 and defining a through hole 116. A radially outward extending flange 118 is located at the top of the cylindrical portion 112. The flange 118 defines a bayonet keyway 120 which has a vertical opening 122 and a lateral opening 124 which is wider than the vertical opening and which defines a locking location 125 which is laterally spaced apart from the vertical opening 122. According to the invention, the outer wall 114 of the cylindrical portion 112 is cut from the top 126 of the cylindrical portion 112 to a point 128 above the bottom 130 of the cylindrical portion 112 thereby defining a side opening to access the through hole 116. The width of the cut can be defined as an angular measurement. In the illustrated second embodiment, the angle is approximately 90°. The fixed sleeve 100 is preferably incorporated into a template such as those described in the previously incorporated co-assigned patents and the template is preferably modified to have a side cut corresponding to the side opening in the outer wall 114 of the fixed sleeve 100.

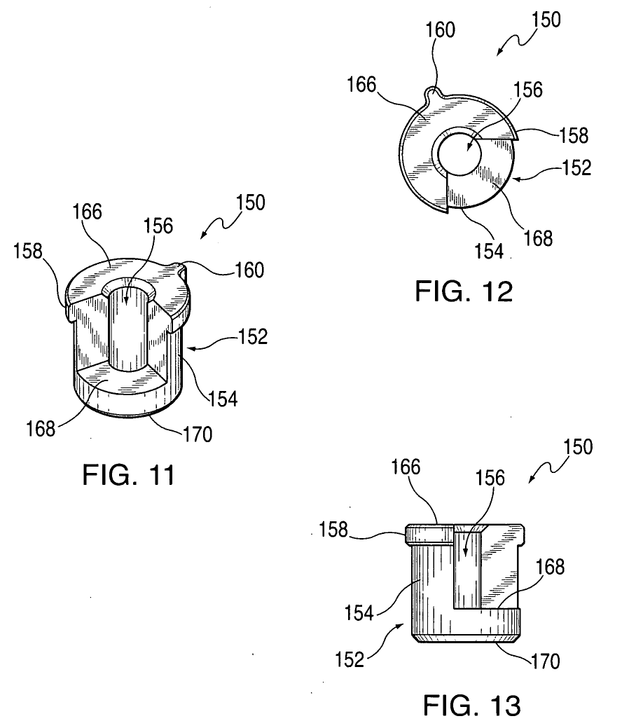

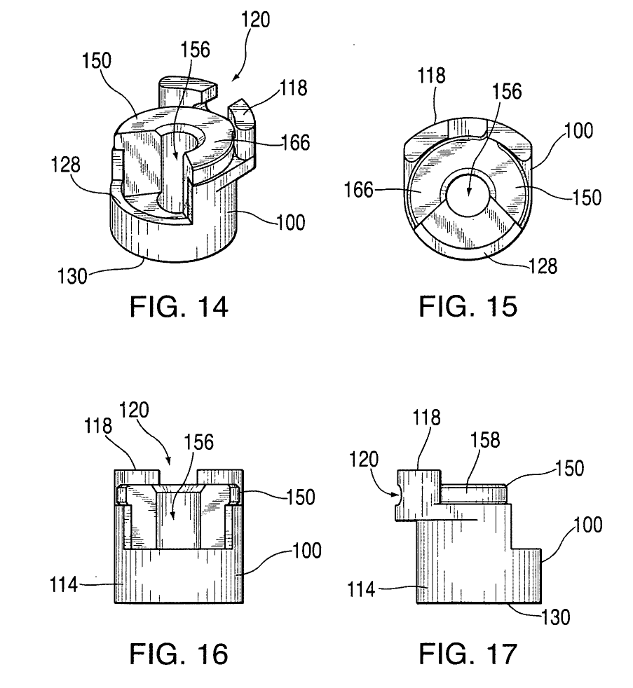

Referring now to FIGS. 11-13, a removable sleeve 150 according to a second embodiment of the invention includes a generally cylindrical portion 152 having an outer wall 154 and defining a through hole 156. A radially outward extending flange 158 is located at the top of the cylindrical portion 152. A key 160 extends radially outward from the flange 158. According to the invention, the outer wall 154 is cut from the top 166 of the flange 158 to a point 168 in the outer wall 154 above the bottom 170 of the outer wall 154 thereby defining a side opening to access the through hole 156. The width of the cut can be defined as an angular measurement. In the illustrated embodiment, the angle is approximately 90°. The outer diameter of the cylindrical portion 152 is dimensioned to fit snugly into the through hole 116 of the fixed sleeve 100 (FIGS. 7-10). The flange 158 is dimensioned to fit into the flange 118 of the fixed sleeve 100 with the key 160 extending through the vertical opening 122 and lateral opening 124 of the bayonet keyway 120. In use, the sleeve 150 is inserted into the sleeve 100 with the key 160 dropping vertically through the vertical opening 122 of the bayonet keyway 120. The sleeve 150 is then rotated so that the key 160 traverses the lateral opening 124 of the keyway 120 until it is positioned at the locking location 125. At the locking location, the lateral opening in the wall 154 aligns with the lateral opening in the wall 114. This is shown in FIGS. 14-17. According to the invention, multiple removable sleeves 150 are provided, each having a different diameter through hole 156. In practice, a sleeve 150 with a relatively small diameter through hole 156 is inserted first into the sleeve 100 and locked in position. A drill (not shown) having a diameter corresponding to the diameter of the through hole 156 is moved laterally and-axially inward through the lateral opening in the fixed sleeve 100 and the lateral opening in the removable sleeve 150 until it is axially aligned with the center of through hole 156 and it is then moved vertically downward into the through hole 156 to drill a guide hole in the patient's jaw bone. Thereafter, the sleeve 150 is removed and optionally replaced with a sleeve having a larger diameter through hole 156. This process may be repeated several times until the final desired diameter hole in the patient's jaw bone is achieved.

As can further be appreciated, other modifications may be made to suit a particular application. For example, while it is preferred that the fixed or master sleeve and removable sleeve be locked together to maintain the respective alignment of the cut-away sections thereof, this is not always necessary. Similarly, although the fixed and removable cylindrical sleeves preferably have continuous cylindrical base sections, i.e., the ring-like section of fixed sleeve 12, 120 which extends 360° between point 28, 128 and bottom 30, 130 of cylindrical portion 12, 112 and the ring-like section of removable sleeve 50, 150 which extend 3600 between point 68, 168 and bottom 70, 170 of cylindrical portion 54, 154 to afford better structural integrity of the respective sleeves, the cut-out sections could extend the entire height of the sleeves for applications where sleeve structural integrity is not critical or required. Furthermore, the configuration and angle of opening of the cut-out sections can also be made larger or smaller depending on the particular dimensions of the dental drill or tool. In addition, instead of the bayonet type alignment means, other mechanical “male-female” means for aligning the cut-outs may be employed.

There have been described and illustrated herein several embodiments of easy access sleeves for dental drills. While particular embodiments of the invention have been described, it is not intended that the invention be limited thereto, as it is intended that the invention be as broad in scope as the art will allow and that the specification be read likewise. It will therefore be appreciated by those skilled in the art that yet other modifications could be made to the provided invention without deviating from its spirit and scope as claimed.

What is claimed is:

1. A dental tool guide assembly, comprising:
master sleeve having a generally cylindrical wall defining an axially extending, centrally arranged through hole and a cut-out in said cylindrical wall ; and
a generally cylindrical removable sleeve removably mountable within said through bore of said master sleeve and having a generally cylindrical wall defining an axially extending centrally arranged through hole and a cut-off in said cylindrical wall thereof, wherein said removable sleeve is rotatably mountable within said master sleeve so as to permit alignment of said cut-outs thereof to permit a generally upright dental tool to pass laterally and radially inward through said cut-outs until it is located within the through hole of said removable sleeve whereupon it may be moved axially downwardly through said through hole to perform a dental task on a patient.

2. The guide assembly according to claim 1, wherein:
said master sleeve has an upper end and a lower end, and
said cut-out thereof extends from said upper end to a location above said lower end, said cut-out having a width no greater than 180°.

3. The guide assembly according to claim 1, wherein:
said cut-out has a width of no greater than approximately 90°.

4. The guide assembly according to claim 1, wherein:
said removable sleeve cylindrical wall has an upper end and a lower end, and said cut-out thereof extends from said upper end thereof to a location above said lower end thereof, said cut-out having a width no greater than approximately 180°.

5. The guide assembly according to claim 4, wherein:
said cut-out of said removable sleeve has a width no greater than approximately 90°.

6. The guide assembly according to claim 1, wherein:
said cut-outs in said master and removable sleeves correspond in size.

7. The guide assembly according to claim 1, wherein:
said removable sleeve has an outer diameter slightly less than the diameter of the through hole of said master sleeve.

8. The guide assembly according to claim 1, additionally including a plurality of removable sleeves, each having a through hole of a different diameter.

9. The guide assembly according to claim 1, wherein:
said cut-out in said removable sleeve provides approximately 180° lateral access to said through-hole thereof.

10. The guide assembly according to claim 1, additionally including means for aligning and locking the position of said master sleeve and said removable sleeve so their respective cut-outs are aligned with one another.

11. The guide assembly according to claim 10, wherein:
said means for aligning and locking comprise a key and a keyway, and wherein one of said master sleeve and said removable sleeve is provided with said key and the other thereof is provided with said keyway in which key is receivable so as to lock said sleeves in a fixed position relative to one another in which said cut-outs thereof are aligned.
